(19) United States
(12) Patent Application Publication
(10) Pub. No.: US 2020/0113219 A1
(43) Pub. Date: Apr. 16, 2020

(54) OPACITY MODIFYING AGENTS FOR EDIBLE PRODUCTS

(71) Applicant: Sensient Colors LLC, St. Louis, MO (US)

(72) Inventors: Michael Charles Jelavich, St. Louis, MO (US); Gale Denise Myers, St. Louis, MO (US); Andreas Klingenberg, Reinbek (DE)

(21) Appl. No.: 16/549,347

(22) Filed: Aug. 23, 2019

Related U.S. Application Data
(63) Continuation of application No. 15/872,646, filed on Jan. 16, 2018, now abandoned.
Application No. 15/872,646 is a continuation of application No. 14/441,333, filed on May 7, 2015, now abandoned.
(60) Provisional application No. 61/724,791, filed on Nov. 9, 2012.

(51) Int. Cl. A23L 29/212; A23G 3/42; A23G 3/36; A23L 5/41

(52) U.S. Cl. CPC A23L 29/212; A23G 3/42; A23V 2002/00; A23L 5/41; A23G 3/36

(57) ABSTRACT

An opacity modifying agent in particulate form comprising a starch, a dextrin, an optional film former, and an optional binder is disclosed herein. Also provided is an opacity modifying suspension comprising the opacity modifying agent and a liquid. The opacity modifying agent or suspension can be added to edible products to provide increased opacity. Methods of producing the opacity modifying agent are also disclosed.

### CROSS-REFERENCE TO RELATED APPLICATIONS

This application is a continuation of U.S. patent application Ser. No. 14/441,333, filed May 7, 2015, which is a U.S. national stage filing under 35 U.S.C. 371 of International Application No. PCT/US2013/069284, filed Nov. 8, 2013, which claims priority to U.S. Provisional Patent Application No. 61/724,791, filed Nov. 9, 2012, each of which is incorporated herein by reference in its entirety.

### BACKGROUND

Opacity modifying agents are an effective means of preventing, light penetration in food products.

Colorants such as titanium dioxide and calcium carbonate have been used as opacity modifying agents. However, with interest in all natural food products increasing, there remains a need for effective opacity modifying agents that do not contain these components.

### SUMMARY

In an aspect, an opacity modifying agent is provided.

This disclosure provides opacity modifying agents in particulate form comprising a starch, a dextrin, an optional film former, an optional binder and optional processing aids.

This disclosure also provides methods for making an opacity modifying agent in particulate form, the method comprising combining a starch, a dextrin, an optional film former, an optional binder, and an optional processing aid to form the opacity modifying agent. This disclosure also provides methods for making an opacity modifying agent in particulate form, the method comprising combining a starch, a dextrin, an optional film former, an optional binder, an optional processing aid and a spray dry fluid to form a spray dry composition, and spray drying the spray dry composition to form the opacity modifying agent.

This disclosure provides opacity modifying agents comprising starch in an amount from about 25% to about 99.99% by weight of the agent, starch in an amount from about 60% to about 95% by weight of the agent, or starch in an amount from about 75% to about 90% by weight of the agent. This disclosure provides opacity modifying agents comprising dextrin in an amount from about 0.1% to about 25% by weight of the agent, dextrin in an amount from about 0.5% to about 15% by weight of the agent, or dextrin in an amount from about 2.5% to about 10% by weight of the agent. This disclosure provides opacity modifying agents comprising film former in an amount of less than about 25% by weight of the agent, film former in an amount of less than about 15% by weight of the agent, or film former in an amount from about 0.25% to about 10% by weight of the agent. This disclosure provides opacity modifying agents comprising binder in an amount of less than about 25% by weight of the agent, binder in an amount of less than about 5% by weight of the agent, or binder in an amount from about 0.25% to about 2.5% by weight of the agent. This disclosure provides opacity modifying agents comprising processing aid in an amount of less than about 25% by weight of the agent, processing aid in an amount of less than about 10% by weight of the agent, or processing aid in an amount, from about 0.25% to about 5% by weight of the agent.

This disclosure provides opacity modifying agents wherein the starch is selected, for example, from the group consisting of unmodified corn starch, modified corn starch, unmodified tapioca starch, modified tapioca starch, unmodified potato starch, modified potato starch, unmodified rice starch, modified rice starch, unmodified wheat starch, modified wheat starch, alkaline treated starch, acid treated starch, bleached starch, roasted starch, hydroxypropyl starch, oxidized starch, and combinations thereof. This disclosure provides opacity modifying agents wherein the dextrin is selected, for example, from the group consisting of branched dextrin, unbranched dextrin, maltodextrin, amylodextrin, corn dextrin and combinations thereof. This disclosure provides opacity modifying agents wherein the film former is selected, for example, from the group consisting of agar, alginate, carrageenan, cassia, cellulose, caboxymethyl cellulose, gellan gum, guar gum, hydroxypropyl cellulose, hydroxypropyl methyl cellulose, konjac, locust bean, methylcellulose, microcrystalline cellulose, pectin, xanthan gum, karaya gum, tragacanth, gum arabic, zein and combinations thereof.

This disclosure provides opacity modifying agents wherein the binder is selected, for example, from the group consisting of sucrose, molasses, calcium stearate, glycierin, propylene glycol, magnesium sulfate, mineral oil, oleic acid, alginate, calcium stearoyl lactylate, cholic acid, gelatin, hydroxylated lecithin, lecithin, partially hydrolyzed oil, polyglycerol polyricinoleate, sorbitan monostearate, stearate, polysorbate 80, polysorbate, quillaia, sorbitan monolaurate and combinations thereof. This disclosure provides opacity modifying agents wherein the processing aid is selected, for example, from the group consisting of methyl paraben, ethyl paraben, propyl paraben, sodium benzoate, H₃PO₄, ascorbic acid, citric acid, potassium sorbate, benzoic acid, ethylenediaminetetraacetic acid, glycerin, propylene glycol, tetrasodium pyrophosphate, NaCO₃, CaCO₃, NaH₂PO₄, calcium diacetate, calcium hexametaphosphate, CaHPO₄, K₂HPO₄, Na₂HPO₄, sodium gluconate, sodium hexametaphosphate, sodium metaphosphate, NaH₂PO₄, Na₄P₂O₇, coconut oil ester, polyvinyl acetate), KMnO₄, NaOH, KOH, HCl, sorbitol, sucrose ester, wax and combinations thereof.

This disclosure provides opacity modifying agents, wherein the agent has an L* value when dispersed in a first sugar syrup comprising two-parts sucrose and one-part water by weight that is at least about 1% less than an L* value as measured in transmission mode or 1% greater than an L* value as measured in reflectance mode of a corresponding sugar syrup comprising a corresponding starch in an amount by weight equal to the amount by weight of the agent or the amount by weight of the starch in the agent, the corresponding starch not provided with a dextrin, a film former or a binder. A corresponding sugar syrup is a sugar syrup comprising sucrose and water in a ratio equal to the first sugar syrup. A corresponding starch is a starch of the same type as the starch in the opacity modifying agent. This disclosure also provides opacity modifying agents, wherein a substance coated by a coating containing the agent has an L* value that is at least about 1% greater than an L* value as measured in reflectance mode of the substance coated by a coating containing a corresponding starch in an amount by weight equal to the amount by weight of the agent, or the amount by weight of the starch in the agent but not containing a dextrin, a film former or a binder. This disclosure also provides opacity modifying agents, wherein the agent has a degrees Brix value when dispersed in a first sugar syrup comprising two-parts sucrose and one-part water by weight that is at least about 1% greater than a degrees. Brix value of a corresponding sugar syrup comprising a corresponding starch in an amount by weight equal to the amount by weight of the agent.

This disclosure also provides opacity modifying suspensions comprising an opacity modifying agent and a liquid. This disclosure provides opacity modifying suspensions comprising the opacity modifying agent in an amount from about 0.1% to about 50% by weight of the suspension. This disclosure provides opacity modifying suspensions comprising the liquid in an amount from about 50% to about 99.9% by weight of the suspension. This disclosure provides opacity modifying suspensions wherein the liquid is selected from the group consisting of water, ethanol, isopropanol, propylene glycol, oil and combinations thereof. This disclosure also provides opacity modifying agents which are in particulate form, such as dry powder or granules.

This disclosure also provides methods of modifying the opacity of an edible substance, the method comprising contacting the edible substance with an opacity modifying agent or opacity modifying suspension according to this invention. This disclosure provides methods wherein the opacity of the edible substance increased by at least about 10%.

Other aspects and embodiments of the disclosure will become apparent to one of skill in the art in light of the following description.

### BRIEF DESCRIPTION OF THE DRAWINGS

FIG. 1 is a photograph showing dragees coated with coatings containing varying amounts of opacity modified agents as described in Example 7.

FIG. 2 is a photograph showing the comparative coating strength of a coating containing opacity modifying agents versus a coating containing Fusion White as described in Example 11.

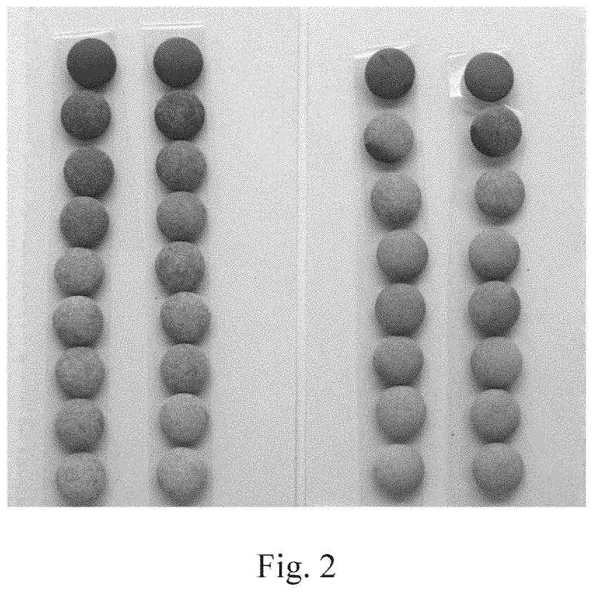

### DETAILED DESCRIPTION

The present disclosure is not limited to the specific details of construction, arrangement of components, or method steps set forth herein. The compositions and methods disclosed herein are capable of being made, practiced, used, carried out and/or formed in various ways that will be apparent to one of skill in the art in light of the disclosure that follows. The phraseology and terminology used herein is for the purpose of description only and should not be regarded as limiting to the scope of the claims. Ordinal indicators, such as first, second, and third, as used in the description and the claims to refer to various structures or method steps, are not meant to be construed to indicate any specific structures or steps, or any particular order or configuration to such structures or steps. All methods described herein can be performed in any suitable order unless otherwise indicated herein or otherwise clearly contradicted by context. The use of any and all examples, or exemplary language (e.g., “such as”) provided herein, is intended merely to facilitate the disclosure and does not imply any limitation on the scope of the disclosure unless otherwise claimed. No language in the specification, and no structures shown in the drawings, should be construed as indicating that any non-claimed element is essential to the practice of the disclosed subject matter. The use herein of the terms “including,” “comprising,” or “having,” and variations thereof, is meant to encompass the elements listed thereafter and equivalents thereof, as well as additional elements. Embodiments recited as “including,” “comprising,” or “having” certain elements are also contemplated as “consisting essentially of” and “consisting of” those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like. All percentages referring to amounts are by weight unless indicated otherwise.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

In an aspect, the disclosure provides affordable and easy-to-use opacity modifying agents. In an aspect, the disclosure provides opacity modifying suspensions comprising opacity modifying agents. In an aspect, the disclosure provides methods for making opacity modifying agents. In an aspect, the disclosure provides methods for using opacity modifying agents.

A starch may include any carbohydrate composed of amylose and amylopectin that is capable of functioning as part of an opacity modifying agent according to this invention. Examples of starches include, but are not limited to, unmodified corn starch, modified corn starch, unmodified tapioca starch, modified tapioca starch, unmodified potato starch, modified potato starch, unmodified rice starch, modified rice starch, unmodified wheat starch, modified wheat starch, alkaline treated starch, acid treated starch, bleached starch, roasted starch, hydroxypropyl starch, oxidized starch, and the like. A variety of examples of commercially available starches exist and may include, for example, PenPure® 30 rice starch (available from Penford Food Ingredients, Centennial, Colo.), EmCap® Starches (available from Cargill, Minnetonka, Minn.), and Ultra-Sperse® Corn Starches (available from Ingredion, Westchester, Ill.).

A dextrin may include any one, or the mixture, of water-soluble, intermediate polysaccharides formed during the hydrolysis of starch to sugar that is capable of functioning as part of an opacity modifying agent according to this invention. Examples of dextrins include, but are not limited to, branched dextrin, unbranched dextrin, maltodextrin, amylodextrin, corn dextrin, and the like. A variety of examples of commercially available dextrins exist and may include, for example, Maltrin® M040 Maltodextrin (available from Grain Processing Corp, Muscatine, Iowa) and AVEBE MD 20 (available from Avebe, Veendam, Netherlands).

A film former may contribute to the smooth suspension and coating properties of the compositions disclosed herein. Examples of film formers include, but are not limited to, agar, alginate, carrageenan, cassia, cellulose, caboxymethyl cellulose, gellan gum, guar gum, hydroxypropyl cellulose, hydroxypropyl methyl cellulose, konjac, locust bean, methylcellulose, microcrystalline cellulose, pectin, xanthan gum, karaya gum, tragacanth, gum arabic, zein (i.e. corn zein), and the like. A variety of examples of commercially available film formers exist and may include, for example, Spectracel HPMC compositions (available from Sensient Technologies, Milwaukee, Wis.).

A binder may contribute to the physical stability of the compositions disclosed herein. Examples of binders include, but are not limited to, sucrose, molasses, calcium stearate, glycerin, propylene glycol, magnesium sulfate, mineral oil, oleic acid, alginate, calcium stearoyl lactylate, cholic acid, gelatin, hydroxylated lecithin, lecithin, partially hydrolyzed oil, polyglycerol polyricinoleate, sorbitan monostearate, stearate, polysothate 80, polysorbate, quillaia, sorbitan monolaurate, wax, and the like. A variety of examples of commercially available binders exist and may include, for example Glycerine (available from Univar, Kent, Wash.) and Q-Naturale™ 200 (available from Ingredion, Westchester, Ill.).

Examples of waxes may include, but are not limited to, paraffin wax, candelilla wax, beeswax, carnauba wax, and combinations thereof.

Processing aids may provide improved properties to the opacity modifying agents and food products contacted by said agents, such as acting as preservatives, as carrier or flow agents, or otherwise improving the physical properties of the opacity modifying agents. Examples of processing aids include, but are not limited to, preservatives, talc, calcium carbonate, clay, ammonium chloride, silica, sodium sulfate, calcium phosphate, propylene glycol dicaprylate/dicaprate, medium chain triglycerides (e.g., fractionated coconut oil), glyceryl monostearate, propylene glycol, polypropylene glycol, polyethylene glycol, triacetin, glycerin, dibutyl sebacate, triglycerides, acetylated monoglycerides, glycerol monstearates, glycerin monostearate, oleic acid, stearic acid, sorbitol, tributyl citrate, acetyltributyl citrate, dibutyl phthalate, triethyl citrate, triethanolamine, aqueous emulsions of glyceryl monostearate and triethyl citrate and combinations thereof. Examples of preservatives may include, but are not limited to, methyl paraben, ethyl paraben, propyl paraben, sodium benzoate, H₃PO₄, ascorbic acid, citric acid, potassium sorbate, benzoic acid, ethylenediaminetetraacetic acid (EDTA), glycerin, propylene glycol and combinations thereof.

Plasticizing agents may enhance the characteristics of solids containing the opacity modifying agent of the present invention, such as adhesion, flexibility, permeability, and the like. In embodiments, plasticizing agents may include medium chain triglycerides, fatty acids, fatty acid derivatives, and combinations thereof. In some embodiments, examples of plasticizing agents may include, but are not limited to, propylene glycol dicaprylate/dicaprate, medium chain triglycerides (e.g., fractionated coconut oil), glyceryl monostearate, propylene glycol, polypropylene glycol, polyethylene glycol, triacetin, glycerin, dibutyl sebacate, triglycerides, acetylated monoglycerides, glycerol monstearates, glycerin monostearate, oleic acid, stearic acid, sorbitol, tributyl citrate, acetyltributyl citrate, dibutyl phthalate, triethyl citrate, triethanolamine, aqueous emulsions of glyceryl monostearate and triethyl citrate, and combinations thereof. Commercially available examples of propylene glycol dicaprylate/dicaprate include, for example, Miglyol® 840 (available from Sasol GmbH) and Neobee® M-20 (available from Stepan Co.).

Examples of colorants which may be used include dyes, lakes, and pigments. Alternatively, the opacity modifying agent or product formed from the opacity modifying agent may be substantially free of one or more dyes, lakes and pigments. In certain embodiments, the opacity modifying agent may contain less than about 0.01% or less than about 0.1% by weight of one or more of the dyes, lakes or pigments disclosed herein. Dyes lakes and pigments include, but are not limited to, iron oxides, titanium dioxide, calcium carbonate, clay, talc, barium sulfate, white carbon, chromium oxide, zinc oxide, zinc sulfide, zinc powder, metal powder pigments, iron black, yellow iron oxide, red iron oxide, chrome yellow, carbon black, molybdate orange, Prussian Blue, ultramarine blue, cadmium type pigments, fluorescent pigments, phthalocyanine pigments, condensed polycyclic pigments, composite oxide pigments, graphite, mica (such as, muscovite, phlogopite, synthetic mica, and fluorine tetra silicon mica), dyes such as, for example, soluble azo dyes, insoluble azo dyes, condensed azo dyes, FD&C Lakes, Carmine Lake, FD&C Blue no. 1, FD&C Red no. 3, FD&C Red no. 40, FD&C Yellow no. 5, FD&C Yellow no. 6, FD&C Green no. 3, alumina, annatto extract, canthaxanthin, caramel, β-carotene, carmine, dihydroxyacetone, tumeric oleoresin, cochineal extract, gardenia yellow, gardenia blue, beet powder, grape skin extract, riboflavin, purple sweet potato, red sweet potato, chlorophyll-containing extracts, pearlescent pigments, SensiPearl™ Blue, Silver, and Bright Silver (available from Sensient Colors, Inc), natural colorants, and the like. Other examples of colorants are found in 21 C.F.R. §§ 73 and 74, which are hereby fully incorporated by reference.

Surfactants may function as wetting agents, lowering surface tension and interfacial tension. Examples of surfactants include, but are not limited to, polysorbates (polyethoxylated sorbitan fatty acid derivatives) such as, for example, polysorbate 80; polyglyceryl 10 laurate; lecithins; mono- and di-glycerides; propylene glycol; sodium lauryl sulfate; acetylated monoglycerides; additives of propyl gallate and citric acid and stabilizers therein; alcohol; alkali metal and ammonium salts of ethylene diamine tetracetic acid, nitrilo triacetic acid, citric acid, phosphoric acid, tartaric acid, glycolic acid, malic acid, lactic acid, acetic acid, and benzoic acid; and combinations thereof.

Buffering agents may impart anionic/cationic ratios of minerals of sodium, potassium, magnesium, and/or calcium. Examples of buffering agents include, but are not limited to, citric acid and sodium citrate. Suitable buffering agents can be selected based on the particular formulation and/or application.

Examples of liquids may include, but are not limited to, water, ethanol, isopropanol, propylene glycol, glycerine, oil and combinations thereof. Examples of suitable oils may include, but are not limited to, palm oil, vegetable oil, soybean oil, cottonseed oil, coconut oil and combinations thereof.

The opacity modifying agent can include starch in an amount of at least about 25%, at least about 30%, at least about 35%, at least about 40%, at least about 45%, at least about 50%, at least about 55%, at least about 60%, at least about 65%, at least about 70%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, or at least about 90% by weight of the agent. The opacity modifying agent can include starch in an amount of at most about 99.99%, at most about 99%, at most about 95%, at most about 90%, at most about 89%, at most about 88%, at most about 87%, at most about 86%, at most about 85%, at most about 84%, at most about 83%, at most about 82%, at most about 81%, at most about 80%, at most about 79%, at most about 78%, at most about 77%, at most about 76%, at most about 75%, at most about 70%, at most about 65%, at most about 60%, at most about 55%, at most about 50%, at most about 45%, at most about 40%, at most about 35%, or at most about 30% by weight of the agent. This includes, for example, starch in an amount from about 25% to about 99.99%, about 60% to about 95%, and about 75% to about 90% by weight of the agent. In some embodiments, the starch can include, for example, an unmodified rice starch.

The starch may include protein in an amount of at most about 1%, at most about 0.9%, at most about 0.8%, at most about 0.7%, at most about 0.6%, at most about 0.5%, at most about 0.4%, at most about 0.3%, at most about 0.25%, at most about 0.2%, at most about 0.15%, at most about 0.1%, at most about 0.05%, or at most about 0.01% by weight of the starch. The starch may include fat in an amount of at most about 1%, at most about 0.9%, at most about 0.8%, at most about 0.7%, at most about 0.6%, at most about 0.5%, at most about 0.4%, at most about 0.3%, at most about 0.25%, at most about 0.2%, at most about 0.15%, at most about 0.1%, at most about 0.05%, or at most about 0.01% by weight of the starch. The starch may include H₂O₂ in an amount of at most about 0.5%, at most about 0.4%, at most about 0.3%, at most about 0.25%, at most about 0.2%, at most about 0.15%, at most about 0.1%, at most about 0.05%, or at most about 0.01% by weight of the starch.

The starch may have an average particle size of at most about 1 mm, at most about 0.9 mm, at most about 0.8 mm, at most about 0.7 mm, at most about 0.6 mm, at most about 0.5 mm, at most about 0.45 mm, at most about 0.4 mm, at most about 0.35 mm, at most about 0.3 mm, at most about 0.25 mm, at most about 0.24 mm, at most about 0.23 mm, at most about 0.22 mm, at most about 0.21 mm, at most about 0.20 mm, at most about 0.19 mm, at most about 0.18 mm, at most about 0.17 mm, at most about 0.16 mm, at most about 0.15 mm, at most about 0.14 mm, at most about 0.13 mm, at most about 0.12 mm, at most about 0.11 mm, or at most about 0.10 mm.

The starch may have an average granule size of at least, about 0.01 μm, at least about 0.05 μm, at least about 0.1 μm, at least about 0.5 μm, at least about 1 μm, at least about 1.5 μm, at least about 2 μm, at least about 2.5 μm, at least about 3 μm, at least about 3.5 μm, at least about 4 μm, at least about 4.5 μm, at least about 5 μm, at least about 5.5 μm, at least about 6 μm, at least about 6.5 μm, at least about 7 μm, at least about 7.5 μm, at least about 8 μm, at least about 8.5 μm, at least about 9 μm, or at least about 9.5 μm. The starch may have a granule size of at most about 100 μm, at most about 50 μm, at most about 25 μm, at most about 10 μm, at most about 9.5 μm, at most about 9 μm, at most about 8.5 μm, at most about 8 μm, at most about 7.5 μm, at most about 7 μm, at most about 6.5 μm, at most about 6 μm, at most about 5.5 μm, at most about 5 μm, at most about 4.5 μm, at most about 4 μm, at most about 3.5 μm, at most about 3 μm, at most about 2.5 μm, at most about 2 μm, at most about 1.5 μm, or at most about 1 μm. This includes, for example, a granule size of from about 2 μm to about 8 μm.

The opacity modifying agent can include dextrin in an amount of at least 0%, at least about 0.1%, at least about 0.2%, at least about 0.3%, at least about 0.4%, at least about 0.5%, at least about 0.6%, at least about 0.7%, at least about 0.8%, at least about 0.9%, at least about 1.0%, at least about 1.5%, at least about 2.0%, at least about 2.5%, at least about 3.0%, at least about 3.5%, at least about 4.0%, at least about 4.5%, at least about 5.0%, at least about 6.0%, at least about 7.0%, at least about 8.0%, at least about 9.0%, at least about 10.0%, at least about 11.0%, at least about 12.0%, at least about 13.0%, at least about 14.0%, at least about 15.0%, at least about 16.0%, at least about 17.0%, at least about 18.0%, at least about 19.0%, at least about 20.0%, at least about 21.0%, at least about 22.0%, at least about 23.0%, or at least about 24.0% by weight of the agent. The opacity modifying agent can include dextrin in an amount of at most about 25.0%, at most about 24.0%, at most about 23.0%, at most about 22.0%, at most about 21.0%, at most about 20.0%, at most about 19.0%, at most about 18.0%, at most about 17.0%, at most about 16.0%, at most about 15.0%, at most about 14.0%, at most about 13.0%, at most about 12.0%, at most about 11.0%, at most about 10.0%, at most about 9.0%, at most about 8.0%, at most about 7.0%, at most about 6.0%, or at most about 5.0% by weight of the agent. This includes, for example, dextrin in an amount from 0.1% to about 25.0%, 0.5% to about 15%, and about 2.5% to about 10% by weight of the agent. In some embodiments, the dextrin can include, for example, maltodextrin.

The opacity modifying agent can include film former in an amount of at least 0%, at least about 0.1%, at least about 0.2%, at least about 0.3%, at least about 0.4%, at least about 0.5%, at least about 0.6%, at least about 0.7%, at least about 0.8%, at least about 0.9%, at least about 1.0%, at least about 1.25%, at least about 1.5%, at least about 1.75%, at least about 2.0%, at least about 2.25%, at least about 2.5%, at least about 3%, at least about 4.0%, at least about 4.5%, at least about 5.0%, at least about 6.0%, at least about 7.0%, at least about 8.0%, at least about 9.0%, at least about 10.0%, at least about 11.0%, at least about 12.0%, at least about 13.0%, at least about 14.0%, at least about 15.0%, at least about 16.0%, at least about 17.0%, at least about 18.0%, at least about 19.0%, at least about 20.0%, at least about 21.0%, at least about 22.0%, at least about 23.0%, or at least about 24.0% by weight of the agent. The opacity modifying agent can include film former in an amount of at most about 25.0%, at most about 24.0%, at most about 23.0%, at most about 22.0%, at most about 21.0%, at most about 20.0%, at most about 19.0%, at most about 18.0%, at most about 17.0%, at most about 16.0%, at most about 15.0%, at most about 14.0%, at most about 13.0%, at most about 12.0%, at most about 11.0%, at most about 10.0%, at most about 9.0%, at most about 8.0%, at most about 7.0%, at most about 6.0%, or at most about 5.0% by weight of the agent, at most about 4.0%, at most about 3.0%, at most about 2.5%, at most about 2.25%, at most about 2.0%, at most about 1.75%, at most about 1.5%, at most about 1.25%, at most about 1.0%, at most about 0.75%, or at most about 0.5% by weight of the agent. This includes, for example, film former in an amount from 0.1% to about 25%, 0.5% to about 15%, and about 2.5% to about 10.0% by weight of the agent. In some embodiments, the film former can include, for example, hydroxypropyl methyl cellulose.

The opacity modifying agent can include binder in an amount of at least 0%, at least about 0.25%, at least about 0.5%, at least about 0.75%, at least about 1.0%, at least about 1.25%, at least about 1.5%, at least about 1.75%, at least about 2.0%, at least about 2.25%, at least about 2.5%, at least about 3%, at least about 4%, at least about 5%, at least about 10%, at least about 15%, or at least about 20% by weight of the agent. The opacity modifying agent can include binder in an amount of at most about 25%, at most about 20%, at most about 15%, at most about 10%, at most about 5%, at most about 4%, at most about 3%, at most about 2.5%, at most about 2.25%, at most about 2.0%, at most about 1.75%, at most about 1.5%, at most about 1.25%, at most about 1.0%, at most about 0.75%, or at most about 0.5% by weight of the agent. This includes, for example, binder in an amount from 0% to about 25%, 0% to about 5%, and about 0.25% to about 2.5% by weight of the agent. In some embodiments, the binder can include, for example, sunflower lecithin, polysorbate 80 or a combination thereof.

In certain embodiments, the opacity modifying agent may include no titanium dioxide, no calcium carbonate, or no titanium dioxide and no calcium carbonate. In certain embodiments, the opacity modifying agent may be substantially free of one or both of titanium dioxide and calcium carbonate. In certain embodiments, the opacity modifying agent may contain less than about 0.01% or less than about 0.1% by weight of one or both of titanium dioxide and calcium carbonate.

The opacity modifying agent may have an average particle size of at most about 10.0 mm, at most about 9.0 mm, at most about 8.0 mm, at most about 7.0 mm, at most about 6.0 mm, at most about 5.0 mm, at most about 4.0 mm, at most about 3.0 mm, at most about 2.0 mm, at most about 1.0 mm, at most about 0.9 mm, at most about 0.8 mm, at most about 0.7 mm, at most about 0.6 mm, at most about 0.5 mm, at most about 0.45 mm, at most about 0.4 mm, at most about 0.35 mm, at most about 0.3 mm, at most about 0.25 mm, at most about 0.24 mm, at most about 0.23 mm, at most about 0.22 mm, at most about 0.21 mm, at most about 0.20 mm, at most about 0.19 mm, at most about 0.18 mm, at most about 0.17 mm, at most about 0.16 mm, at most about 0.15 mm, at most about 0.14 mm, at most about 0.13 mm, at most about 0.12 mm, at most about 0.11 mm, or at most about 0.10 mm.

In an aspect, the disclosure provides an opacity modifying suspension comprising an opacity modifying agent and a liquid.

The opacity modifying suspension can include opacity modifying agent in an amount of at least about 0.1%, at least about 0.5%, at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 21%, at least about 22%, at least about 23%, at least about 24%, at least about 25%, at least about 30%, at least about 35%, at least about 40%, or at least about 45% by weight of the suspension. The opacity modifying suspension can include opacity modifying agent in an amount of at most about 50%, at most about 45%, at most about 40%, at most about 35%, at most about 30%, at most about 25%, at most about 24%, at most about 23%, at most about 22%, at most about 21%, at most about 20%, at most about 19%, at most about 18%, at most about 17%, at most about 16%, at most about 15%, at most about 14%, at most about 13%, at most about 12%, at most about 11%, at most about 10%, at most about 9%, at most about 8%, at most about 7%, at most about 6%, at most about 5%, at most about 4%, at most about 3%, at most about 2%, or at most about 1% by weight of the suspension. This includes, for example, opacity modifying agent in an amount of from about 0.1% to about 50%, about 0.5% to about 25%, and about 5% to about 20% by weight of the suspension.

The opacity modifying suspension can include liquid in an amount of at least about 50%, at least about 55%, at least about 60%, at least about 65%, at least about 70%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99% by weight of the suspension. The opacity modifying suspension can include liquid in an amount of at most about 99.9%, at most about 99%, at most about 98%, at most about 97%, at most about 96%, at most about 95%, at most about 94%, at most about 93%, at most about 92%, at most about 91%, at most about 90%, at most about 89%, at most about 88%, at most about 87%, at most about 86%, at most about 85%, at most about 84%, at most about 83%, at most about 82%, at most about 81%, at most about 80%, at most about 79%, at most about 78%, at most about 77%, at most about 76%, at most about 75%, at most about 70%, at most about 65%, at most about 60%, at most about 55%, at most about 50% by weight of the suspension. This includes, for example, liquid in an amount from about 50% to about 99.9%, about 75% to about 99.5%, and about 80% to about 95% by weight of the suspension. In some embodiments, the liquid can include, for example, water, ethanol, isopropanol, propylene glycol, glycerine, oil or a combination thereof.

In an aspect, the disclosure provides a method of making an opacity modifying agent.

In one embodiment, the method may comprise combining a starch, a dextrin, an optional film former, an optional binder, and an optional processing aid to form the opacity modifying agent, such as by dry blending. The dust which forms while forming the agent may be reduced compared with dust formed when processing the starch with no dextrin, no binder, no film former or a combination thereof.

In another embodiment, the method may comprise combining a starch, a dextrin, an optional film former, an optional binder, an optional processing aid and a spray dry fluid to form a spray dry composition, and spray drying the spray dry composition to form the opacity modifying agent. In some embodiments, the spray dry fluid may comprise water or preservatives.

In an aspect, the disclosure provides a method of modifying the opacity of an edible substance such as a food substance. In some embodiments, the method may comprise contacting the edible or food substance with the opacity modifying agent or a suspension comprising the opacity modifying agent of this invention. In one embodiment, the opacity modifying agent is mixed with sugar syrup to provide a sugar syrup with increased opacity.

The opacity modifying agents may be used in edible products such as food, pharmaceutical or nutraceutical applications. The edible products may be intended for use in mammals, including, without, limitation, rodents, canines, felines, non-human primates, ungulates, and humans. The opacity modifying agents can be used in pharmaceutical or non-pharmaceutical dosage units. Suitable food products include, without limitation, cereal, panned goods, baked goods, extruded foods, pet treats, beverages, icings, syrups, gummies, hard candy, licorice, and the like. The opacity modifying agents may be coated onto the edible product, be dispersed throughout the edible product, or layered in the edible product.

The opacity modifying agents may be used to modify the opacity of cosmetic products, personal care products, hair care products, paints, inks, plastics, leather and other surface treatments, and combinations thereof. Cosmetic products can include, but are not limited to, mascaras, pressed powder make-ups (e.g., eye shadows, cheek rouge and facial powders), liquid make-ups (e.g., eye shadows, foundations, cheek rouge, blushes, lip liners, eye liners and nail enamel), lipsticks, or combinations thereof. Personal care products can include, but are not limited to, lotions, creams, gels, toothpastes, or combinations thereof.

Substances contacted by the disclosed opacity modifying agents exhibit high opacity. Lightness can be assessed by any suitable method, such as, for example, measuring the Lightness Index according to ASTM Method E313 with a D65/10° illumination source (referred to as “E313 [065/10]”) using a LabScan™ XE spectrophotometer (available from HunterLab, Inc.). A sample can be prepared, for instance, by dispersing 5% by weight of an opacity modifying agent into a substance such as a sugar syrup comprising two-parts sucrose to one-part water by weight. A sample can also be prepared by coating a substrate with the aforementioned dispersion. A sample is loaded into the instrument's sample port and scanned, and the Lightness Index (E313 [D65/10]) value is calculated using measurements taken on the CIE L*a*b* color scale. The resulting Lightness Index value is used to assess lightness of the sample.

Suitably, substances contacted by the disclosed opacity modifying agents can exhibit high E313 [065/10] values of at least about 50, at least about 55, at least about 60, at least about 65, at least about 70, at least about 75, at least about 80, at least about 85, at least about 90, at least about 91, at least about 92, at least about 93, at least about 94, at least about 95, at least about 96, at least about 97, or at least about 98. Suitably, the disclosed opacity modifying agents can increase the E313 [065/10] values of a food product upon contacting said product by at least about 5, at least about 10, at least about 15, at least about 20, at least about 25, at least about 30, at least about 35, at least about 40, at least about 45, at least about 50, at least about 55, at least about 60, at least about 65, at least about 70, at least about 75, at least about 80, at least about 85, at least about 90, at least about 95, at least about 96, or at least about 97. Opacity can be assessed by evaluating the Lightness. Index achieved upon coating one or more colored substrate cores with film coatings as described herein. For example, when coating a colored substrate, the Lightness Index will increase with additional weight gain until high and/or full opacity is reached. Upon reaching high and/or full opacity, the Lightness Index may level off relative to further increases in weight gain. Suitably, the disclosed film coatings can suitably provide high and/or full opacity at a weight gain of less than about 10%, less than about 9%, less than about 8%, less than about 7%, less than about 6%, less than about 5%, or less than about 4%, at least about 0.01%, at least about 0.1%, at least about 0.5%, at least about 1%, at least about 2%, at least about 3%, or at least about 4% weight gain, for example, about 3% to about 10% weight gain. In some embodiments, the disclosed opacity modifying agent is present in amounts sufficient to provide full/high opacity at low weight gain.

In some embodiments, substances contacted by the disclosed opacity modifying agents may exhibit an increase in L* as measured in reflectance mode or a decrease in L* as measured in transmission mode of at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.25%, at least about 1.5%, at least about 1.75%, at least about 2%, at least about 2.25%, at least about 2.5%, at least about 3%, at least about 3.5%, at least about 4%, at least about 4.5%, at least about 5%, at least about 6%, at least about 7%, at least about 8%, at least about 9%, at least about 10%, at least about 11%, at least about 12%, at least about 13%, at least about 14%, or at least about 15% compared with substances contacted by a corresponding starch in an amount by weight equal to the amount by weight of the agent or the amount by weight of the starch in the agent, but not contacted by a dextrin, a film former or a binder.

In some embodiments, substances contacted by the disclosed opacity modifying agents may exhibit an increase in L* as measured in reflectance mode or a decrease in L* as measured in transmission mode of at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.25%, at least about 1.5%, at least about 1.75%, at least about 2%, at least about 2.25%, at least about 2.5%, at least about 3%, at least about 3.5%, at least about 4%, at least about 4.5%, at least about 5%, at least about 6%, at least about 7%, at least about 8%, at least about 9%, at least about 10%, at least about 11%, at least about 12%, at least about 13%, at least about 14%, or at least about 15% compared with substances contacted by a corresponding dextrin in an amount by weight equal to the amount by weight of the agent or the amount by weight of the dextrin in the agent, but without a starch and without the corresponding film former and binder.

In some embodiments, substances contacted by the disclosed opacity modifying agents may exhibit an increase in L* as measured in reflectance mode or a decrease in L* as measured in transmission mode of at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.25%, at least about 1.5%, at least about 1.75%, at least about 2%, at least about 2.25%, at least about 2.5%, at least about 3%, at least about 3.5%, at least about 4%, at least about 4.5%, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, or at least about 75% compared with substances contacted by a corresponding film former or binder in amounts by weight equal to the amount by weight of the agent or the amounts by weight of the film former or binder in the agent, but without starch and without dextrin.

In some embodiments, substances coated by coatings containing the disclosed opacity modifying agents may exhibit an increase in L* as measured in reflectance mode of at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.25%, at least about 1.5%, at least about 1.75%, at least about 2%, at least about 2.25%, at least about 2.5%, at least about 3%, at least about 3.5%, at least about 4%, at least about 4.5%, at least about 5%, at least about 6%, at least about 7%, at least about 8%, at least about 9%, at least about 10%, at least about 11%, at least about 12%, at least about 13%, at least about 14%, or at least about 15% compared with substances coated by a coating containing a corresponding starch in an amount by weight equal to the amount by weight of the agent or the amount by weight of the starch in the agent, but not containing a dextrin, a film former or a binder.

In some embodiments, substances coated by coatings containing the disclosed opacity modifying agents may exhibit an increase in L* as measured in reflectance mode of at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.25%, at least about 1.5%, at least about 1.75%, at least about 2%, at least about 2.25%, at least about 2.5%, at least about 3%, at least about 3.5%, at least about 4%, at least about 4.5%, at least about 5%, at least about 6%, at least about 7%, at least about 8%, at least about 9%, at least about 10%, at least about 11%, at least about 12%, at least about 13%, at least about 14%, or at least about 15% compared with substances coated by coatings containing a corresponding dextrin in an amount by weight equal to the amount by weight of the agent or the amount by weight of the dextrin in the agent, but without a starch and without the corresponding film former and binder.

In some embodiments, substances coated by coatings containing the disclosed opacity modifying agents may exhibit an increase in L* as measured in reflectance mode of at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.25%, at least about 1.5%, at least about 1.75%, at least about 2%, at least about 2.25%, at least about 2.5%, at least about 3%, at least about 3.5%, at least about 4%, at least about 4.5%, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, or at least about 75% compared with substances coated by coatings containing a corresponding film former or binder in amounts by weight equal to the amount by weight of the agent or the amounts by weight of the film former or binder in the agent, but without starch and without dextrin.

Substances contacted by the disclosed opacity modifying agents may exhibit high brightness. Brightness can assessed by any suitable method, such as, for example, using a LabScan™ XE spectrophotometer to measure the amount of light reflected at 457 nm. A sample is loaded into the instrument's sample port and scanned, and the resulting reflectance at 457 nm is used to assess brightness of the sample. Suitably, the substances contacted by the disclosed opacity modifying agent may have a high brightness value of at least about 80, at least about 81, at least about 82, at least about 83, at least about 84, at least about 85, at least about 86, at least about 87, at least about 88, at least about 89, at least about 90, at least about 91, at least about 92, at least about 93, at least about 94, at least about 95, at least about 96, or at least about 97. In some embodiments, the disclosed opacity modifying agent is present in amounts sufficient to provide high brightness.

Substances contacted by the disclosed opacity modifying agents may exhibit increased index of refraction. Index of refraction can be measured by any suitable method, such as, for example, dispersing 5% by weight of an opacity modifying agent into a sugar syrup comprising two-parts sucrose to one-part water by weight and measuring the increase in index of refraction using a temperature compensated Leica 10432 hand-held refractometer. In some instances, the change in index of refraction can be represented by a change in the degrees Brix value. Suitably, substances contacted by the disclosed opacity modifying agents may exhibit an increase in degrees Brix value of at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.25%, at least about 1.5%, at least about 1.75%, at least about 2%, at least about 2.25%, at least about 2.5%, at least about 3%, at least about 3.5%, at least about 4%, at least about 4.5%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 21%, at least about 22%, at least about 23%, at least about 24%, or at least about 25% when compared with the substance not contacted by the opacity modifying agent. In some embodiments, the disclosed opacity modifying agent is present in amounts sufficient to provide high index of refraction.

In some embodiments, substances contacted by the disclosed opacity modifying agents may exhibit an increase in degrees Brix value of at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.25%, at least about 1.5%, at least about 1.75%, at least about 2%, at least about 2.25%, at least about 2.5%, at least about 3%, at least about 3.5%, at least about 4%, at least about 4.5%, at least about 5%, at least about 6%, at least about 7%, at least about 8%, at least about 9%, or at least about 10% compared with substances contacted by a corresponding starch in an amount by weight equal to the amount by weight of the agent or the amount by weight of the starch in the agent, but not contacted by a dextrin, and without, the corresponding film former and binder. In some embodiments, substances contacted by the disclosed opacity modifying agents may exhibit an increase in degrees Brix value of at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.25%, at least about 1.5%, at least about 1.75%, at least about 2%, at least about 2.25%, at least about 2.5%, at least about 3%, at least about 3.5%, at least about 4%, at least about 4.5%, at least about 5%, at least about 10%, at least about 15%, at least about 20%, at least about 25%, at least about 30%, at least about 35%, at least about 40%, at least about 45%, or at least about 50% compared with substances contacted by the corresponding film former and binder but without starch and without dextrin.

The compositions and suspensions described herein can be manufactured using techniques and equipment that are known and commonly used in the art. Manufacturing steps such as order of component addition, mixing temperatures (heating and/or cooling), mixing time, mixing speed, etc. can be driven by either by formulation or equipment requirements, or both. A number of parameters can be modified during the manufacturing process without substantial effect on the efficacy of the resulting product. The manufacturing methods and processes can further include separate steps for validating the resulting composition (e.g., the total amounts, ratios, and even distribution of components in the composition, etc.).

The following examples are provided for illustrative purposes only and should not be construed as limiting.

### EXAMPLES

Materials. “Rice Starch” is a native rice starch with roughly 12-13% moisture content that has been processed to remove excess protein and fat, having a bulk density of roughly 0.49 g/ml, particle size of less than 0.18 mm, and rice granule size of roughly 2-8 microns. PenPuree 30 is a native rice starch (available commercially from Penford Food Ingredients, Centennial, Colo.). ClearGum® LG 7015 is a high amylose starch (available commercially from Roquette America, Keokuk, Iowa). Ultra-Sperse® corn starch is a corn starch (available commercially from Ingredion, Westchester, Ill.). Ultra-Sperse® 3 is a starch derived from tapioca (available commercially from Ingredion, Westchester, Ill.). Thingum 107 is a native corn starch (available commercially from Tate & Lyle, London, England). Tic. Pretested® Gum Arabic SD FCC Powder is a spray dry powder gum arabic produced from the exudate from acacia trees (available commercially from Tic Gum, White Marsh, Md.). Ticaxan® Xanthan Gum Powder is an all-natural thickener and stabilizer (available commercially from Tic Gum, White Marsh, Md.). Maltrin® M040 Maltodextrin is a 5 dextrose equivalent, bland, white, powdered carbohydrate (available commercially from Grain Processing Corp., Muscatine, Iowa). K 4484 is a specialty dextrin refined from tapioca starch (available commercially from National Starch Food Innovation, Bridgewater, N.J.). Spectracel 15 FG is a low-viscosity hydroxypropyl methyl cellulose where the viscosity of a 2% solution in water measure at 20° C. is from 12.0 cP to 18.0 cP (available commercially from Sensient Colors, St. Louis, Mo.). Crillet® 4 Veg GMO-free polysorbate 80 is an ethoxylated sorbitan ester emulsifier (available commercially from Croda, Lanchashire, England). Topcithin® SF is a clean label, non-GM, sunflower lecithin sunflower lecithin that does not require labeling as an allergin (available commercially from Cargill, Minnetonka, Minn.). Propylparaben NF and Methylparaben NF (available commercially from Malinckrodt, St Louis, Mo.). Sodium benzoate, H₃PO₄, citric acid, ascorbic acid, and potassium sorbate (available commercially from Apac Corp., Arcadia, Calif.). “Fusion White” is a commercially available opacity modifying agent containing rice starch, tapioca starch, and sunflower lecithin, but no film former or dextrin (available commercially from Sensient Food Colors Europe, Geesthacht, Germany).

### Example 1. Opacity Modifying Agents Prepared by Spray Drying

Spray dried compositions detailed in Table 1 were prepared by mixing the dry ingredients in a mix chamber of a plow mixer (Littleford; Florence, Ky.). Liquid components were added to the chamber to form the spray dry composition. The spray dry compositions were spray dried on a Buchi mini spray dryer B-290 to produce opacity modifying agents according to this invention. Values are reported in percent by weight of the composition.

TABLE 1
Spray Dry Compositions.

| | Agent | | | | | |
|---|---|---|---|---|---|---|
| Component | 1-A | 1-B | 1-C | 1-D | 1-E | 1-F |
| Water | 90.0 | 90.0 | 90.0 | 90.0 | 90.0 | 90.0 |
| Rice Starch | 8.5 | 8.5 | 8.5 | 8.5 | 8.5 | 8.5 |
| Maltodextrin | 0.8 | 0.8 | 0.8 | 0.8 | 0.8 | 0.8 |
| HPMC E-15 | 0.422 | 0.390 | 0.370 | 0.400 | 0.310 | 0.470 |
| GMO-Free Polysorbate 80 | 0.13 | 0.13 | 0.13 | 0.13 | 0.13 | 0.13 |
| Sunflower Lecithin | 0.10 | 0.10 | 0.10 | 0.10 | 0.10 | 0.10 |
| Methyl Paraben | 0.04 | | | | | |
| Propyl Paraben | 0.008 | | | | | |
| Sodium Benzoate Solution (1.5M) | | 0.06 | | | 0.06 | |
| H₃PO₄ Solution (5.3M) | | 0.02 | | 0.02 | | |
| Ascorbic Acid | | | 0.10 | | 0.10 | |
| Potassium Sorbate | | | | 0.05 | | |

### Example 2. Opacity Modifying Agents Prepared by Dry Mixing

The opacity modifying agents of Table 2 were prepared by mixing the ingredients in a mix chamber of a plow mixer. Values are reported in percent by weight of the composition.

TABLE 2
Opacity Modifying Agents.

| | Agent | |
|---|---|---|
| Component | 2-A | 2-B |
| Rice Starch | 80 | 85 |
| Maltodextrill | 10 | 8 |
| Sunflower Lecithin | 3 | 1 |
| Gum Arabic SD | 7 | |
| HPMC E-15 | | 6 |

### Example 3. Formulations

The opacity modifying agents of Tables 3 and 4 were prepared according to the methods of this invention. Values are reported in percent by weight of the composition. Opacity experiments were performed by coating colored substrates with film coatings containing the opacity modifying agents. The opacity performance was evaluated by visual inspection and the results are reported in Tables 3 and 4.

TABLE 3
Opacity Modifying Agents.

| | Agent | | | | | | | | | | |
|---|---|---|---|---|---|---|---|---|---|---|---|
| Component | 3-A | 3-B | 3-C | 3-D | 3-E | 3-F | 3-G | 3-H | 3-I | 3-J | 3-K |
| Rice Starch | 70 | | | | | | | | | | |
| ClearGum ® LG 7015 | | 70 | 80 | | | | | | | | |
| Ultra-sperse ® | | | | 70 | 80 | | | | | | |
| Ultra-sperse ® 3 | | | | | | 70 | 80 | | | | |
| PenPure ® 30 | | | | | | | | 70 | 90 | | |
| Thingum ™107 | | | | | | | | | | 70 | 80 |
| Maltodextrin | 20 | 20 | 10 | 20 | 10 | 20 | 10 | 20 | 5 | 20 | 10 |
| Sunflower Lecithin | 7 | 7 | 7 | 7 | 7 | 7 | 7 | 7 | 3 | 7 | 7 |
| Gum Arabic SD | 3 | 3 | 3 | 3 | 3 | 3 | 3 | 3 | 2 | 3 | 3 |
| Visual Inspection | Ok | Ok | Ok | Ok | Good | Ok | Ok | Ok | Ok | Ok | Ok |

TABLE 4
Opacity Modifying Agents.

| | Agent | | |
|---|---|---|---|
| Component | 3-L | 3-M | 3-N |
| Rice Starch | 80 | 80 | 80 |
| Maltodextrin | | 10 | 10 |
| K 4484 | 10 | | |
| Sunflower Lecithin | 3 | 3 | 3 |
| Gum Arabic SD | 7 | | |
| HPMC E-15 | | 7 | |
| Xanthan Gum | | | 7 |
| Visual Inspection | Ok | Good | Good |

### Example 4. Opacity Modifying Agent

The opacity modifying agent shown in Table 5 was prepared by combining the ingredients with water using an Oster blender to make a composition containing 20% by weight opacity modifying agent and 80% by weight water. The resulting composition was spray dried on a Buchi B-290 spray drier set to a 200° C. inlet temperature, a 90° C. outlet temperature, and an 18% pump rate. After spray drying, the opacity modifying Agent 4 contained 5.65% moisture. Values are reported in percent by weight of the composition.

TABLE 5
Opacity Modifying Agent.

| Component | Agent 4 |
|---|---|
| Citric Acid | 0.10 |
| Ascorbic Acid | 0.40 |
| Potassium Sorbate | 1.50 |
| Sunflower Lecithin | 0.50 |
| HPMC E-15 | 4.75 |
| Maltodextrin | 7.75 |
| Rice Starch | 85.00 |

### Example 5. Refractive Index

A 66° Bx sugar syrup having 2 parts sucrose to 1 part water was prepared as a carrier. 1%, 5%, 10%, and 15% by weight compositions of Agent 4 and Rice Starch were prepared using the 66° Bx sugar syrup as carrier. The refractive index of each composition was measured using a Leica 10432 44-77° Brix Hand-held Refractometer. The 1%, 5%, 10%, and 15% by weight compositions of Agent 4 exhibited a measured refractive index of 67.5° Bx, 68° Bx, 69° Bx, and 70° Bx, respectively. The 1%, 5%, 10%, and 15% by weight compositions of Rice Starch exhibited a measured refractive index of 66° Bx, 66° Bx, 66.5° Bx, and 66.5° Bx, respectively.

### Example 6. Colorimetry of Sugar Syrups Containing Opacity Modifying Agents

The compositions of Table 6 were prepared with a sugar syrup having 2 parts sucrose to 1 part water as a carrier. 20 mL of the resulting compositions was placed in a clean cuvette and introduced into an X-Rite Color i-5 Colorimeter using a 25-mm port in total transmission mode. The resulting colorimetry data are shown in Table 6. ΔE values were computed using the sugar syrup as a control. dL* values are a comparison between the L* value of a composition containing Agent 4 at a certain percent weight and the composition containing an individual component of Agent 4 at the same percent weight. dΔE values are a comparison between the ΔE value of a composition containing Agent 4 at a certain percent weight and the composition containing an individual component of Agent 4 at the same percent weight.

TABLE 6
Colorimetry of Sugar Syrups.

| | | Conc. | | | | | | |
|---|---|---|---|---|---|---|---|---|
| | | (% w/w | | | | | | |
| Composition | Component | Carrier) | L* | a* | b* | ΔE | dL* | dΔE |
| 6-Control | Sugar Syrup | 100 | 95.77 | −0.18 | 1.48 | 0 | 0 | 0 |
| 6-1 | Agent 4 | 1 | 50.44 | −0.57 | 1.93 | 45.33 | 0 | 0 |
| 6-2 | Agent 4 | 5 | 42.98 | 0.05 | 4.45 | 52.87 | 0 | 0 |
| 6-3 | Agent 4 | 10 | 34.54 | −0.06 | 5.95 | 61.39 | 0 | 0 |
| 6-4 | Agent 4 | 15 | 24.71 | 1.18 | 10.94 | 71.70 | 0 | 0 |
| 6-5 | Rice Starch | 1 | 63.61 | 0.19 | 2.99 | 32.20 | −13.17 | 13.13 |
| 6-6 | Rice Starch | 5 | 44.44 | −0.21 | 2.84 | 51.35 | −1.46 | 1.52 |
| 6-7 | Rice Starch | 10 | 39.51 | −0.29 | 3.92 | 56.31 | −4.97 | 5.08 |
| 6-8 | Rice Starch | 15 | 33.89 | −0.29 | 5.05 | 61.98 | −9.18 | 9.72 |
| 6-9 | Maltodextrin | 1 | 93.48 | −0.2 | 1.09 | 2.32 | −43.04 | 43.01 |
| 6-10 | Maltodextrin | 5 | 75.4 | −0.2 | 0.94 | 20.38 | −32.42 | 32.49 |
| 6-11 | Maltodextrin | 10 | 46.99 | −0.09 | 2.15 | 48.78 | −12.45 | 12.61 |
| 6-12 | Maltodextrin | 15 | 39.28 | 0.44 | 2.75 | 56.51 | −14.57 | 15.19 |
| 6-13 | HPMC E-15 | 1 | 86.37 | −0.37 | 1.45 | 9.40 | −35.93 | 35.93 |
| 6-14 | HPMC E-15 | 5 | 51.74 | −0.8 | 4.23 | 44.12 | −8.76 | 8.75 |
| 6-15 | HPMC E-15 | 10 | 43.79 | −1.48 | 8.42 | 52.46 | −9.25 | 8.93 |
| 6-16 | HPMC E-15 | 15 | 44.17 | −1.5 | 8.68 | 52.12 | −19.46 | 19.58 |

### Example 7. Colorimetry of Panned Dragees

120 mL of a composition containing 5% by weight of Sensient Brown Lake Aqueous Dispersion (available commercially from Sensient Colors, St. Louis, Mo.) in a 68° Bx sugar syrup was applied to 2000 grams of naked dragees over 12 coat applications using a hard panning technique to produce brown coated dragees. 25 mL of each of compositions 6-Control and 6-1 to 6-16 were applied to 100 grams of naked dragees and 400 grams of brown coated dragees over 10 coat applications using a hard panning technique to produce final dragees for measuring colorimetry data. The colorimetry data were measured on final dragees produced from brown coated dragees. Colorimetry data were measured using an X-Rite Color i-5 Colorimeter operating in total reflectance mode. The resulting colorimetry data are shown in Table 7. “Coating Comp.” indicates the composition that was applied to coat the brown coated dragees. ΔE values were computed using the brown coated dragees as a control. dL* values are a comparison between the L* value of a final dragee (produced from a brown coated dragee) that was coated by a composition containing Agent 4 at a certain percent weight and the composition containing an individual component of Agent 4 at the same percent weight. dL* (SS) values are a comparison between the L* value of a final dragee (produced from a brown coated dragee) coated by the indicated composition and a final dragee (produced from a brown coated dragee) coated by a sugar syrup (composition 6-Control). dΔE values are a comparison between the ΔE value of a final dragee (produced from a brown coated dragee) that was coated by a composition containing Agent 4 at a certain percent weight and the composition containing an individual component of Agent 4 at the same percent weight. dΔE (SS) values are a comparison between the ΔE value of a final dragee (produced from a brown coated dragee) coated by the indicated composition and a final dragee (produced from a brown coated dragee) coated by a sugar syrup (composition 6-Control).

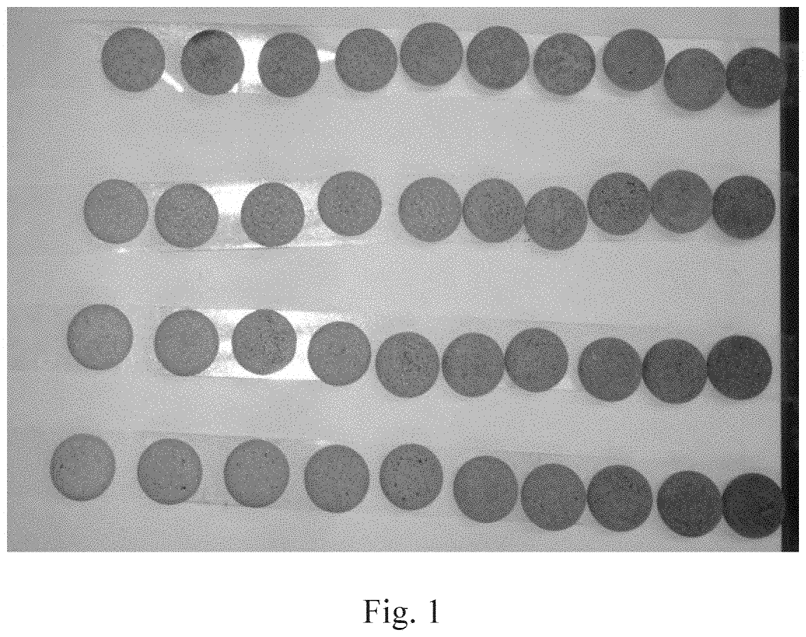

FIG. 1 shows the results of panning application for Dragees 7-1 (top row), 7-2 (second row from top), 7-3 (second row from bottom), and 7-4 (bottom row). The rows are arranged such that the rightmost dragee contains 1 coat, the 2^{nd}-rightmost dragee contains 2 coats, etc., the 2^{nd}-leftmost dragee contains 9 coats, and the leftmost dragee contains 10 coats.

TABLE 7
Colorimetry of Coated Dragees.

| | Coating | | | | | | | dL* | dΔE |
|---|---|---|---|---|---|---|---|---|---|
| Dragee | Comp. | L* | a* | b* | ΔE | dL* | dΔE | (SS) | (SS) |
| 7-Control | None | 51.49 | 8.64 | 5.92 | 0.00 | 0.00 | 0.00 | −8.19 | 11.08 |
| 7-1 | 6-1 | 58.12 | 1.60 | 1.40 | 10.67 | 0.00 | 0.00 | −1.56 | 3.55 |
| 7-2 | 6-2 | 74.61 | 0.75 | −2.31 | 25.78 | 0.00 | 0.00 | 14.93 | 15.50 |
| 7-3 | 6-3 | 74.87 | 0.82 | −2.61 | 26.09 | 0.00 | 0.00 | 15.19 | 15.78 |
| 7-4 | 6-4 | 75.49 | 1.03 | −2.34 | 26.50 | 0.00 | 0.00 | 15.81 | 16.30 |
| 7-5 | 6-5 | 67.04 | 2.42 | −2.29 | 18.65 | 8.92 | 9.69 | 7.36 | 7.89 |
| 7-6 | 6-6 | 67.51 | 1.50 | −2.40 | 19.41 | −7.10 | 7.14 | 7.83 | 8.62 |
| 7-7 | 6-7 | 68.36 | 1.35 | −2.59 | 20.25 | −6.51 | 6.53 | 8.68 | 9.49 |
| 7-8 | 6-8 | 72.09 | 1.48 | −2.20 | 23.27 | −3.40 | 3.43 | 12.41 | 12.90 |
| 7-9 | 6-9 | 66.03 | 2.30 | 3.42 | 16.06 | 7.91 | 8.19 | 6.35 | 7.59 |
| 7-10 | 6-10 | 67.72 | 2.58 | −1.50 | 18.85 | −6.89 | 7.17 | 8.04 | 8.34 |
| 7-11 | 6-11 | 64.95 | 3.99 | −1.26 | 15.95 | −9.92 | 10.50 | 5.27 | 5.39 |
| 7-12 | 6-12 | 49.96 | 6.04 | 1.68 | 5.20 | −25.53 | 26.33 | −9.72 | 10.04 |
| 7-13 | 6-13 | 58.91 | 1.85 | −1.62 | 12.57 | 0.79 | 3.13 | −0.77 | 2.98 |
| 7-14 | 6-14 | 61.47 | 2.82 | 1.07 | 12.53 | −13.14 | 13.72 | 1.79 | 2.68 |
| 7-15 | 6-15 | 63.67 | 3.78 | −0.65 | 14.67 | −11.20 | 11.75 | 3.99 | 4.06 |
| 7-16 | 6-16 | 59.46 | 2.47 | −1.80 | 12.70 | −16.03 | 16.10 | −0.22 | 2.49 |
| 7-17 | 6-Control | 59.68 | 4.36 | −0.20 | 11.08 | −15.81 | 16.30 | 0.00 | 0.00 |

### Example 8. Colorimetry of Dry Powder

Samples of Agent 4, anatase titanium dioxide (available commercially from Sensient Colors, St. Louis, Mo.) and eggshell calcium carbonate (available commercially from Sensient Colors, St. Louis, Mo.) were introduced to an X-Rite Color i-5 Colorimeter operating in total reflectance mode and colorimetry data were acquired, which are presented in Table 8. dL* is the difference in L* relative to titanium dioxide.

TABLE 8
Colorimetry of Dry Powder.

| Component | L* | a* | b* | dL* |
|---|---|---|---|---|
| Titanium | 97.14 | −0.27 | 0.67 | 0 |
| Dioxide | | | | |
| Calcium | 93.39 | −0.24 | 1.81 | −3.75 |
| Carbonate | | | | |
| Agent 4 | 97.89 | −1.51 | 3.94 | 0.75 |

### Example 9. Particle Size Analysis

Samples of Agent 4, anatase titanium dioxide (available commercially from Sensient Colors, St. Louis, Mo.) eggshell calcium carbonate (available commercially from Sensient Colors, St. Louis, Mo.) and Fusion White were introduced to a Malvern liquid particle size analyzer using Microtrac version 10.2.1 software. Results of the particle size analysis are shown in Table 9.

TABLE 9
Particle Size Analysis.

| | | smallest particle | largest particle |
|---|---|---|---|
| | mean particle | size measured | size measured |
| Component | size (μm) | (μm) | (μm) |
| Agent 4 | 46.23 | 1.156 | 352 |
| Titanium Dioxide | 6.83 | 0.061 | 74 |
| Calcium | 168.7 | 1.635 | 418.6 |
| Carbonate | | | |
| Fusion White | 67.88 | 1.156 | 418.6 |

### Example 10. Comparison with Titanium Dioxide and Calcium Carbonate

Agent 4, anatase titanium dioxide (available commercially from Sensient Colors, St. Louis, Mo.) and eggshell calcium carbonate (available commercially from Sensient. Colors, St. Louis, Mo.) were each added to a separate sugar syrup to form a coating composition that is 5% by weight of its respective additive. Naked chocolate dragees were coated with each of the coating compositions to the same weight gain. Dragees coated with the composition containing Agent 4 exhibited slightly more opacity in the coating than dragees coated with the composition containing calcium carbonate. Dragees coated with the composition containing Agent 4 exhibited weaker opacity in the coating than dragees coated with the composition containing titanium dioxide.

### Example 11. Comparison with Fusion White

Two kilograms of chocolate dragees were coated with a coating composition containing 3.1 g of FD&C Blue No. 1 in 1 kg of sugar syrup to produce blue coated dragees. Half of the blue coated dragees were coated by a hard panning method with 100 g of a composition containing 0.55% by weight of Agent 2-B of Example 2 and the remainder sugar syrup. The other half of the blue coated dragees were coated by a hard panning method with 100 g of a composition containing 11% by weight of Fusion White and the remainder sugar syrup. FIG. 11 shows the comparative coating effect of blue coated dragees coated with Fusion White (left two columns, with dragees from top to bottom containing an increasing number of coats) versus the coating effect of blue coated dragees coated with Agent 2-B (right two columns, with dragees from top to bottom containing an increasing number coats). Visual inspection indicated that the coating effect was slightly improved in dragees coated with Agent 2-B over dragees coated with a comparable number of coats of Fusion white. However, the coating composition containing Fusion White was twenty-times more concentrated, indicating that Agent 2-B was at least twenty-times more effective as an opacity modifying agent as Fusion white. During panning with the composition containing Fusion White, there was significant development of dust, however, during panning with the composition containing Agent 2-B, there was no significant formation of dust.

What is claimed is:

1. An opacity modifying agent in particulate form comprising a starch, a dextrin, a film former, and a binder, wherein the agent comprises the starch in an amount from about 75% to about 90% by weight of the agent, wherein the agent comprises the dextrin in an amount from about 2.5% to about 10% by weight of the agent, and wherein the agent comprises the film former in an amount from about 0.1% to about 15% by weight of the agent.

2. The agent of claim 1, wherein the starch is selected from the group consisting of unmodified corn starch, modified corn starch, unmodified tapioca starch, modified tapioca starch, unmodified potato starch, modified potato starch, unmodified rice starch, modified rice starch, unmodified wheat starch, modified wheat starch, alkaline treated starch, acid treated starch, bleached starch, roasted starch, hydroxypropyl starch, oxidized starch, and combinations thereof.

3. The agent of claim 1, wherein the dextrin is selected from the group consisting of branched dextrin, unbranched dextrin, maltodextrin, amylodextrin, corn dextrin and combinations thereof.

4. The agent of claim 1, comprising film former in an amount of at least about 0.1% and at most about 7% by weight of the agent.

5. The agent of claim 1, wherein the film former is selected from the group consisting of agar, alginate, carrageenan, cassia, cellulose, caboxymethyl cellulose, gellan gum, guar gum, hydroxypropyl cellulose, hydroxypropyl methyl cellulose, konjac, locust bean, methylcellulose, microcrystalline cellulose, pectin, xanthan gum, karaya gum, tragacanth, gum arabic, zein and combinations thereof.

6. The agent of claim 1, comprising binder in an amount of less than about 25% by weight of the agent.

7. The agent of claim 1, wherein the binder is selected from the group consisting of sucrose, molasses, calcium stearate, glycerin, propylene glycol, magnesium sulfate, mineral oil, oleic acid, alginate, calcium stearoyl lactylate, cholic acid, gelatin, hydroxylated lecithin, lecithin, partially hydrolyzed oil, polyglycerol polyricinoleate, sorbitan monostearate, stearate, polysorbate 80, polysorbate, quillaia, sorbitan monolaurate, wax and combinations thereof.

8. The agent of claim 1, wherein the agent has an L* value when dispersed in a first sugar syrup comprising two-parts sucrose and one-part water by weight that is at least about 1% less than an L* value as measured in transmission mode or 1% greater than an L* value as measured in reflectance mode of a corresponding sugar syrup comprising a corresponding starch in an amount by weight equal to the amount by weight of the agent.

9. The agent of claim 1, wherein the agent has a degrees Brix value when dispersed in a first sugar syrup comprising two-parts sucrose and one-part water by weight that is at least about 1% greater than a degrees Brix value of a corresponding sugar syrup comprising a corresponding starch in an amount by weight equal to the amount by weight of the agent.

10. The agent of claim 1, wherein the agent is substantially free of titanium dioxide, calcium carbonate, or a combination thereof.
